(19) United States
(12) Patent Application Publication
(10) Pub. No.: US 2012/0330919 A1
(43) Pub. Date: Dec. 27, 2012

(54) DETERMINING CROSS-LANGUAGE QUERY SUGGESTION BASED ON QUERY TRANSLATIONS

(75) Inventors: Qiliang Chen, Beijing (CN); Weihua Tan, Beijing (CN)

(73) Assignee: GOOGLE INC., Mountain View, CA (US)

(21) Appl. No.: 13/248,833

(22) Filed: Sep. 29, 2011

Related U.S. Application Data
(63) Continuation of application No. PCT/CN2011/076278, filed on Jun. 24, 2011.

(51) Int. Cl. G06F 17/30

(52) U.S. Cl. 707/706; 707/E17.137

(57) ABSTRACT

Computer-implemented methods, systems, computer program products for generating cross-language query suggestions are described. A pair of machine-generated translations are obtained for a primary-language query suggestion. A first machine-generated translation of the pair is generated by machine-translation from a first language to a second language, while the second machine-generated translation is generated by machine-translation from the second language to the first language. A respective difference measure is determined for each machine-generated translation based on the number of n-grams the machine-generated translation has in common with the primary-language query suggestion. The machine-generated translation that has a smaller number of n-grams in common with the primary-language query suggestion is identified as a preferred choice as a cross-language query suggestion for the primary-language query suggestion. The first language and the second language can be the preferred languages for the primary-language query suggestions and cross-language query suggestions, respectively.

### TECHNICAL FIELD

This specification relates to computer-implemented query suggestion services, and more particularly, to providing cross-language query suggestions.

### BACKGROUND

Search engines can offer input suggestions (e.g., query suggestions) that correspond to a user's query input. The input suggestions include query alternatives to a user-submitted search query and/or suggestions (e.g., auto-completions) that match a partial query input that the user has entered. In order to provide input suggestions that are likely to be relevant to the user's interest and present information needs, search engines evaluate input suggestion candidates based on various criteria before selecting particular input suggestion candidates for presentation to the user.

Internet content related to the same topic or information often exists in different natural languages and/or writing systems on the World Wide Web. A multi-lingual user can try to formulate corresponding queries in different languages and/or writing systems and provide the queries to a search engine to locate relevant content in the different languages and/or writing systems. However, formulating an effective search query in a non-native language or writing system can be challenging for many multi-lingual users, even with the help of a multi-lingual dictionary. A search engine capable of providing cross-language input suggestions (e.g., cross-language query suggestions) can help alleviate this difficulty. Technologies for improving the quality and effectiveness of machine-generated cross-language query suggestions are needed.

### SUMMARY

This specification describes technologies relating to generation of cross-language query suggestions.

In general, one aspect of the subject matter described in this specification can be embodied in methods that include the actions of: receiving a primary-language query suggestion generated for a query input submitted to a search engine; obtaining a pair of machine-generated translations for the primary-language query suggestion, where a first machine-generated translation of the pair is generated based on machine translation from a first language to a second language, and the second machine-generated translation of the pair is generated based on machine translation from the second language to the first language, and where the first language is a user-specified preferred language for the primary-language query suggestion, and the second language is a user-specified preferred language for a cross-language query suggestion corresponding to the primary-language query suggestion; determining a respective count of n-grams that each of the first machine-generated translation and the second machine-generated translation has in common with the primary-language query suggestion, where n is an integer constant; and selecting one of the first machine-generated translation and the second machine-generated translation that has the smaller respective count of n-grams in common with the primary-language query suggestion as the cross-language query suggestion for the primary-language query suggestion.

Other embodiments of this aspect include corresponding computer systems, apparatus, and computer programs recorded on one or more computer storage devices, each configured to perform the actions of the methods. A system of one or more computers can be so configured by virtue of software, firmware, hardware, or a combination of them installed on the system that in operation cause the system to perform the actions. One or more computer programs can be so configured by virtue having instructions that, when executed by a data processing apparatus, cause the apparatus to perform the actions.

In general, one aspect of the subject matter described in this specification can be embodied in methods that include the actions of: receiving a query suggestion generated for a query input submitted to a search engine; obtaining a pair of machine-generated translations for the query suggestion, where a first machine-generated translation of the pair is generated based on machine translation from a first language to a second language, and the second machine-generated translation of the pair is generated based on machine translation from the second language to the first language; and determining a cross-language query suggestion for the query suggestion based on a first comparison between respective sequences of n-grams generated from the query suggestion and the first machine-generated translation, and a second comparison between respective sequences of n-grams generated from the query suggestion and the second machine-generated translation, where n is an integer constant.

Other embodiments of this aspect include corresponding computer systems, apparatus, and computer programs recorded on one or more computer storage devices, each configured to perform the actions of the methods. A system of one or more computers can be so configured by virtue of software, firmware, hardware, or a combination of them installed on the system that in operation cause the system to perform the actions. One or more computer programs can be so configured by virtue having instructions that, when executed by a data processing apparatus, cause the apparatus to perform the actions.

These and other embodiments can optionally include one or more of the following features.

In some implementations, the action of obtaining the pair of machine-generated translations for the query suggestion further includes: sending a first machine-translation request to obtain the first machine-generated translation of the query suggestion, the first machine-translation request specifying the query suggestion as a subject of the first machine-translation request, specifying a preferred language for primary-language query suggestions as a source language of the first machine-translation request, and specifying a preferred language for cross-language query suggestions as a target language of the first machine-translation request; and sending a second machine-translation request to obtain the second machine-generated translation of the query suggestion, the second machine-translation request specifying the query suggestion as a subject of the second-machine translation request, specifying the preferred language for cross-language query suggestions as a source language of the second machine-translation request, and specifying the preferred language for primary-language query suggestions as a target language of the second machine-translation request.

In some implementations, the first language and the second language are a pair of languages selected from a group of distinct languages including an automatically detected language for the query suggestion, a user-specified, preferred language for primary-language query suggestions, and a user-specified, preferred language for cross-language query suggestions.

In some implementations, the methods further include the action of generating the respective sequence of n-grams for each of the query suggestion, first machine-generated translation, and second machine-generated translation, from a respective sequence of characters forming the each of (1) the query suggestion, (2) the first machine-generated translation, and (3) the second machine-generated translation, where each n-gram consists of n consecutive characters from the respective sequence of characters.

In some implementations, the methods further include the action of selecting a value for n based at least on respective lengths of (1) the query suggestion, (2) the first machine-generated translation, and (3) the second machine-generated translation.

In some implementations, the method further includes the action of selecting a value for n based on at least the first language and the second language.

In some implementations, n is 2.

In some implementations, the action of determining the cross-language query suggestion for the query suggestion further includes the actions of: identifying first common n-grams between the respective sequences of n-grams generated from the query suggestion and the first machine-generated translation; identifying second common n-grams between the respective sequences of n-grams generated from the query suggestion and the second machine-generated translation; and identifying one of the first and second machine-generated translations for which a smaller number of common n-grams have been identified, as the cross-language query suggestion for the query suggestion.

In some implementations, the action of determining the cross-language query suggestion for the query suggestion further includes the action of: when an equal number of common n-grams have been identified for the first and second machine-generated translations, identifying one of the first and second machine-generated translations that has a smaller character length as the cross-language query suggestion for the query suggestion.

The actual language of a primary-language query suggestion generated based on a user's query input can sometimes be difficult to ascertain based on machine-implemented language detection techniques. This difficulty arises particularly when the primary-language query suggestion includes words and/or characters from multiple languages or writing systems. This difficulty may also arise when slight variations of the primary-language query suggestion exist in multiple language and writing systems. A default or auto-detected source language designation given to such types of primary-language query suggestions are often erroneous. A machine-generated translation obtained based on such erroneous source language designation is often ineffective at retrieving cross-language content that is on the same topic but in a different language as that targeted by the primary-language query suggestion.

With embodiments of the techniques described in this specification, the search engine can obtain (e.g., by using a machine-translation service) multiple machine-generated candidate translations by specifying different source-target language pairs for translating the primary-language query suggestion. The search engine then identifies a machine-generated candidate translation that is more likely to be a correct translation of the primary-language query suggestion. The identified machine-generated translation also has a higher likelihood of being an effective cross-language query suggestion for retrieving cross-language content that is on the same topic as that targeted by the primary-language query suggestion. Alternatively, the search engine can at least identify and eliminate one or more machine-generated candidate translations that are least likely to serve as a good cross-language query suggestion for the primary-language query suggestion.

By selecting a cross-language query suggestion identified using the techniques described in this specification, a user can retrieve content in a second language that may be more relevant or comprehensive than the content that is retrieved based on the primary-language query suggestion. In addition, a search task can be implemented in an efficient manner and provide a good user experience. Not only can the need for manually translating a primary-language query suggestion be avoided, the effectiveness of a cross-language query suggestion generated based on machine-translation can be improved as well.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a screenshot illustrating an example web page presenting a group of primary-language query suggestions and a group of cross-language query suggestions.

FIGS. 2A and 2B are block diagrams each illustrating example data flow in example techniques that generate query suggestions in different natural languages.

FIG. 3 is a block diagram illustrating an example of a translation comparison technique that identifies a cross-language query suggestion for a primary-language query suggestion from multiple machine-generated translations of the primary-language query suggestion.

FIG. 4 is a flow diagram illustrating an example procedure for determining a cross-language query suggestion from multiple machine-generated translations of a primary-language query suggestion.

Like reference numbers and designations in the various drawings indicate like elements.

### DETAILED DESCRIPTION

A search engine can provide primary-language query suggestions in response to a user inquiry. In some implementations, the primary-language query suggestions include query suggestions generated based on the user's original query input, such as expansions and auto-completions of the user's original query input (e.g., text input entered by a user in a search engine user interface). The primary-language query suggestions are typically written in the same language or writing system as that of the user's original query input. The primary language query suggestions are often generated based on user-submitted search queries stored in one or more query logs.

In some implementations, the search engine can also provide a cross-language query suggestion for each primary-language query suggestion, where the cross-language query suggestion is a query written in a second language or writing system different from that of the primary-language query suggestion. When providing a cross-language query suggestion, a search engine can evaluate a number of candidate translations for the primary-language query suggestion. Based on the evaluation, the search engine can select a candidate translation that is both an accurate translation of the primary-language query suggestion and likely to be an effective search query for retrieving cross-language content that is on the same topic as that targeted by the primary language search query.

In various implementations, the search engine typically employs a machine-translation service to generate the candidate translations for each primary-language query suggestion. For each translation task, the machine-translation server uses a specification of a source language for the primary-language query suggestion and a specification of a target language for the translation. In many cases, automatic language detection for the primary-language query suggestion is straight forward. However, sometimes, machine-based techniques that identify the correct language of the primary-language query suggestion fall short. Moreover, the techniques may have difficulty identifying an appropriate source language for translating the primary-language query suggestion into a suitable cross-language query suggestion.

For example, the primary-language query suggestion can be a mixed language query and include words from multiple languages and/or writing systems. As a specific example, a primary-language query suggestion “Autobot [symbol] ” can be provided in response to a user's original query input “auto”. The primary-language query suggestion includes an English word “Autobot” and a Chinese phrase “ [symbol] ” (means “toy” or “toys” in English). Mixed language queries can often occur in query logs associated with geographic regions where people tend to use multiple languages and/or writing systems interchangeably and/or in combination. Examples of such regions are Hong Kong, Singapore, India, and European countries, etc. When primary-language query suggestions are generated based on these query logs, some of the primary-language query suggestions may also be mix language queries.

Machine-based techniques for identifying a single language of this kind of mixed language queries can produce incorrect results. For example, the auto-detected language for the example primary-language query suggestion “Autobot [symbol] ” is German, and a machine-generated translation of the primary-language query suggestion from German into English is “Autobot [symbol] ”, which is apparently incorrect. In addition, this machine-generated translation based on the incorrect identification of the language for the primary-language query suggestion also leads to a cross-language query suggestion (e.g., “Autobot [symbol] ”). The cross-language query suggestion (e.g., “Autobot [symbol] ”) is identical to the primary-language query suggestion (e.g., “Autobot [symbol] ”), and is thus ineffective in retrieving cross-language content on the same topic (but in a different language) as that targeted by the primary-language query suggestion.

Correctly identifying the language of a primary-language query suggestion using machine-based techniques can also be challenging in cases where the same or slight variations of the words in the primary-language query suggestion exist in multiple languages or writing systems. Sometimes, the search engine may be influenced by a particular spelling of a word in a popular or default language. Under such influence, the search engine may erroneously treat another slightly different word written in a different language as a misspelled word in the popular or default language. For example, “Mousse au Chocolat” is a primary-language query suggestion generated based on a user's query input “Mousse”. “Mousse au Chocolat” is a French query. However, the auto-detected language for the primary language query suggestion “Mousse au Chocolat” is English. A translation of the query suggestion “Mousse au Chocolat” from English into French is also “Mousse au Chocolat.” Since the two query suggestions are identical, they will retrieve the same search results. Therefore, the incorrect source language for the primary-language query suggestion has led to an ineffective cross-language query suggestion for the primary-language query suggestion.

As described in this specification, a translation comparator can be used to obtain a pair of machine-generated translations from a machine-translation service. In some implementations, the pair of machine-generated translations include one translation generated by translating the primary-language query suggestion from a first language to a second, different language. The pair of machine-generated translations also include another translation generated by translating the primary-language query suggestion from the second language to the first language. The first language and the second language can be selected from a group of languages including an auto-detected language for the primary language search query, a user-specified preferred language for the primary-language query suggestions, and a user-specified preferred language for the cross-language query suggestions. In some implementations, the pair of machine-generated translations are each compared with the primary-language query suggestion. A respective difference measure can be determined for each machine-generated translation based on the number of common n-grams between the machine-generated translation and the primary-language query suggestion. The search engine can identify the machine-generated translation that has the least number of n-grams in common with the primary-language query suggestion as the cross-language query suggestion for the primary-language query suggestion. Alternatively, the search engine can identify one or more machine-generated translations that have the most numbers of n-grams in common with the primary-language query suggestion and eliminate the identified machine-generated translations as potential cross-language query suggestions for the primary-language query suggestion.

In some implementations, query length (e.g., the number of characters in a machine-generated translation) can be used to break the tie if the pair of machine-generated candidate translations have the same number of n-grams in common with the primary-language query suggestion.

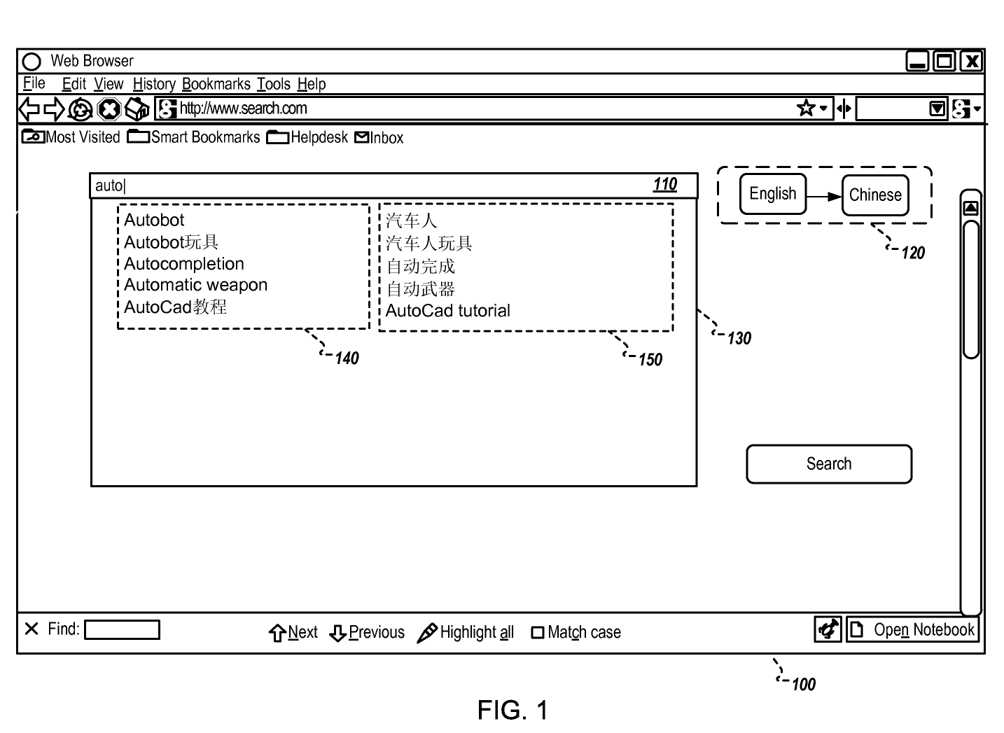

FIG. 1 is a screenshot illustrating an example of a web page 100 presenting a group of primary-language query suggestions and a group of cross-language query suggestions. The web page includes a search query input field 110. The search query input field 110 includes a user-submitted query input “auto”.

In response to the entry of the query input, the user's device requests query suggestions from a suggestion service module (e.g., a suggestion service module provided by the search engine). After the client device receives the primary-language query suggestions, the client device provides the primary-language query suggestions for display in an interface element of the web browser showing the web page 100. In the example of FIG. 1, the interface element is a drop-down menu 130 showing the primary-language query suggestions (e.g., expansions and auto-completions of the user's query input “auto”) in a first portion 140 of the drop-down menu 130.

In the example of FIG. 1, the client device is further configured to request cross-language query suggestions that correspond to the primary-language query suggestions from the suggestion service module. Each cross-language query suggestion is a translation of its corresponding primary-language query suggestion. After receiving the cross-language query suggestions, the client device provides the cross-language query suggestions for display in parallel with the primary-language query suggestions in a distinct second portion 150 of the drop-down menu 130.

In the example of FIG. 1, the association between each primary-language query suggestion and a corresponding cross-language query suggestion is represented visually by the horizontal alignment of the primary-language query suggestion and the corresponding cross-language query suggestion.

In some implementations, the search engine allows the user to specify a preferred language and associated writing system for the primary-language query suggestions, and a preferred language and associated writing system for the cross-language query suggestions. As shown in FIG. 1, the user interface element 120 shows that the user has chosen Chinese as the preferred language for the primary-language query suggestions, and English as the preferred language for the cross-language query suggestions. The user can enter input in any language and/or writing system in the input field 110. The search engine can generate primary-language query suggestions that are expansions and auto-completions of the input based on user-submitted queries stored in query logs associated with the user's preferred language for the primary-language query suggestions.

As set forth earlier in the specification, user-submitted search queries stored in a query log associated with a particular geographic region or language may nonetheless contain mixed language queries and queries written in other languages. Therefore, the primary-language query suggestions generated from the query logs can sometimes include mixed language queries and queries in languages other than the user's preferred language for primary-language query suggestions.

Therefore, as shown in FIG. 1, when providing a cross-language query suggestion corresponding to a primary-language query suggestion, the search engine implementing the translation comparison techniques described in this specification may not completely observe the user's preferred language for the cross-language query suggestions. Instead, a translation is provided as the cross-language query suggestion such that the translation is a correct translation of the primary-language query suggestion in one of the languages that the user is likely to understand. At the same time, the translation will likely be effective in retrieving content that is on the same topic but in a different language as that targeted by the primary-language query suggestion.

For illustrative purposes, FIG. 1 shows that, in response to the user's query input “auto”, five primary-language query suggestions are presented in the portion 140 of the drop-down menu 130. These five primary-language query suggestions include query suggestions written purely in English (e.g., “Autobot”, “autocompletion”, “automatic weapon”), and mixed language query suggestions including both words in English and characters in Chinese (e.g., “Autobot [symbol] ” and “AutoCad [symbol] ”).

The three primary-language query suggestions “Autobot”, “autocompletion” and “automatic weapon” are correctly identified as English queries, and translated into corresponding Chinese queries “ [symbol] ”, “ [symbol] ”, and “ [symbol] [symbol] ”. These three translations in Chinese are presented in the portion 150 in the drop-down menu 130 as cross-language query suggestions for the three primary-language query suggestions.

For the two mixed language queries, the auto-detected language for “Autobot [symbol] ” is German, while the auto-detected language for “AutoCad [symbol] ” is Malay. Both of these auto-detected source language designations are incorrect. A machine-generated translation for the primary-language query suggestion “Autobot [symbol] [symbol] ” from Chinese to English is “Autobot toys”. A machine-generated translation for the primary-language query suggestion “Autobot [symbol] ” from English to Chinese is “ [symbol] [symbol] ”. Between these two machine-generated translations, the search engine has determined that the translation from English to Chinese (e.g., “ [symbol] ”) is more different from the primary-language query suggestion (e.g., “Autobot [symbol] ”) than the translation from Chinese to English (e.g., “Autobot toys”), and is therefore a better choice as the cross-language query suggestion for the primary-language query suggestion. The measure of difference is based on the number of bi-grams each translation has in common with the primary-language query suggestion. A smaller number of common bi-grams indicates a larger difference. For example, “Autobot toys” has four bi-grams in common with “Autobot [symbol] ”, while “ [symbol] ” has only one bi-gram in common with “Autobot [symbol] ”.

For the other mixed primary-language query suggestion “AutoCad [symbol] [symbol] ”, a similar process has also been carried out. “AutoCad” is the name of a software application, which is a known name for the software application in both Chinese and English. “ [symbol] ” means “tutorial” in English. A machine-generated translation for the primary-language query suggestion “AutoCad [symbol] ” from Chinese to English is “AutoCad tutorial”. A machine-generated translation for the primary-language query suggestion “AutoCad [symbol] ” from English to Chinese is “AutoCad [symbol] ”. In this case, the search engine has determined that “AutoCad tutorial” is more different from the primary-language query suggestion “AutoCad [symbol] ” than “AutoCad [symbol] ”. Thus, the translation “AutoCad tutorial” is presented as the cross-language query suggestion for the primary-language query suggestion “AutoCad [symbol] ”. In this example, “AutoCad tutorial” has four bi-grams in common with “AutoCad [symbol] ”, while “AutoCad [symbol] ” have five bi-grams in common with “AutoCad [symbol] ”.

In the example shown in FIG. 1, the user has specified a preferred language (e.g., Chinese) for the primary-language query suggestions and a preferred language (e.g., English) for the cross-language query suggestions. However, translations generated by machine-translations according to the user's preferences can sometimes lead to incorrect translations or ineffective cross-language query suggestions. By obtaining multiple machine-generated translations, each based on a different specification of source and target languages for the translation, the search engine can identify a cross-language query suggestion that is both a correct translation and better serves the user's information needs.

When the user selects one of the query suggestions from the user interface element 130, a search request based on the selected query suggestion is sent to the search engine. A web browser instance is redirected to a web page displaying search results generated by the search engine for the selected query suggestion. For example, if the user selects the primary-language query suggestion “Autobot”, content in English on the robot characters named “Autobots” can be retrieved. If the user selects the corresponding cross-language query suggestion “ [symbol] ”, content in Chinese on those same robot characters can be retrieved. For another example, if the user selects the primary-language query suggestion “AutoCad [symbol] ”, AutoCad software tutorials in Chinese can be retrieved. If the user selects the corresponding cross-language query suggestions “AutoCad tutorials”, the software tutorials in English can be retrieved.

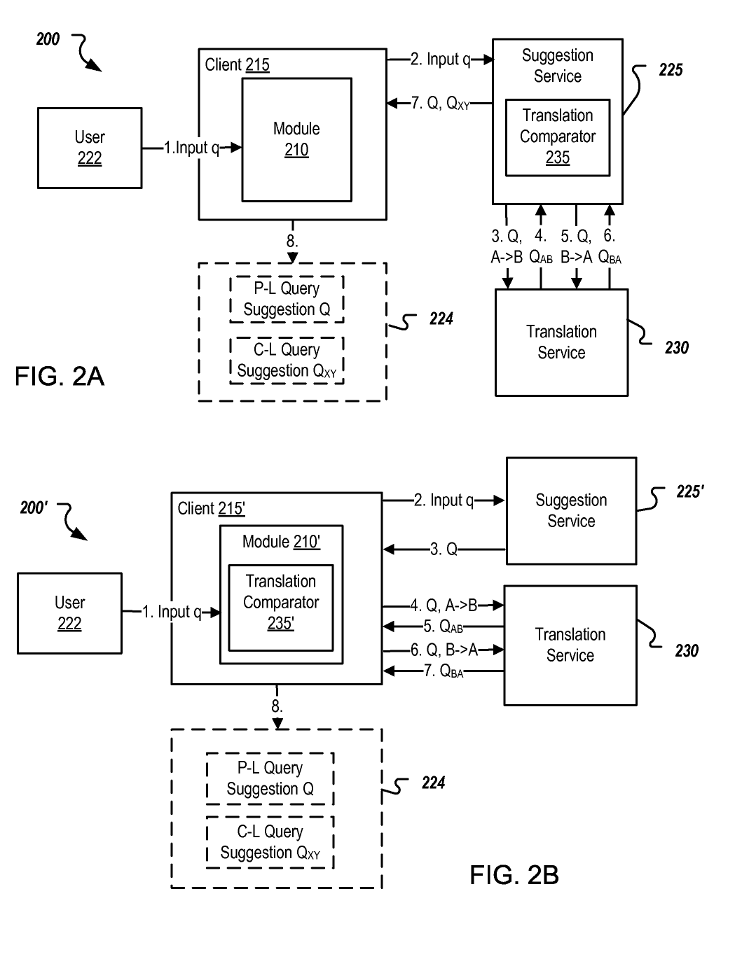

FIG. 2A is a block diagram illustrating example data flow in an example system 200 in which input suggestions (e.g., query suggestions) in different natural languages are provided. In FIG. 2A, a module 210 running on a client device 215 monitors input 220 received in a search engine query input field from a user 222. The input 220 is written as a sequence of characters. Each character has a respective unique encoding that distinguishes it from all other characters in the same or different languages and writing systems. An example of such unique encoding systems is the Unicode system, which provides unique encodings for each of over 109,000 characters, over 93 scripts. For example, the input “auto” includes four English characters: “a”, “b”, “c”, and “d”. An input “ [symbol] ” includes three Chinese characters “ [symbol] ”, “ [symbol] ”, and “ [symbol] ”. An input “ [symbol] movie” includes nine characters “ [symbol] ”, “ [symbol] ”, “ [symbol] ”, a white space, “m”, “o”, “v”, “i”, and “e”.

In some implementations, the module 210 is a JavaScript script executing in a web browser running on the client device 215, or plug-in software installed in a web browser running on the client device 215. In some alternative implementations, the module 210 is installed on an intermediate server that receives the input 220, e.g., from the client device 215. The module 210 receives the input 220 and automatically sends the input 220 to a suggestion service module 225, as the input 220 is received. In some implementations, the suggestion service module 225 is software running on a server (e.g., a server distinct from the intermediate server) that receives a textual input, e.g., a user-submitted query input, and returns alternatives to the textual input, e.g., query suggestions.

The suggestion service module 225 determines a set of primary-language query suggestions based on the user's query input 220. The primary-language query suggestions are alternatives to the input 220, e.g., expansions and completions. As described earlier with respect to FIG. 1, the primary-language query suggestions can include query suggestions that are either related alternative queries or auto-completed queries that match the input 220, and can include queries written in the user's default language, mixed language queries, and/or queries written in any other languages. As shown in the configuration in FIG. 2A, the suggestion service module 225 sends one or more of the primary-language query suggestions to a translation service module 230 in a number of translation requests. In some implementations, the translation requests are generated by a translation comparator 235 of the suggestion service module 225.

In some implementations, the translation service module 230 is software running on a server that receives textual input (e.g., a primary-language query suggestion) and returns alternatives to the textual input that are represented in different writing systems or natural languages, e.g. translations and transliterations. The translation service module 230 implements one or more machine-translation techniques, and translates the received textual input (e.g., the primary-language query suggestion written as a sequence of characters) from a source language to a target language. In some implementations, the suggestion service module 225 (e.g., through the translation comparator 235) specifies the source language and target language for each translation request according to the user-specified, preferred language for the primary-language query suggestions and the user-specified, preferred language for the cross-language query suggestions.

Various machine translation techniques can be used by the translation service module 230 to translate the primary-language query suggestions in response to the translation requests. Examples of the machine-translation techniques include rule-based machine translation techniques, statistical machine translation techniques, example-based machine translation techniques, and combinations of one or more of the above. Other machine-translation techniques are possible.

In some implementations, the suggestion service module 225 (e.g., through the translation comparator 235) sends a pair of translation requests for each primary-language query suggestion Q. One translation request specifies a first language (e.g., language A) as the source language, and a second language (e.g., language B) as the target language for the translation. The other translation request specifies the second language (e.g., language B) as the source language, and the first language (e.g., language A) as the target language for the translation.

In response to the first translation request, the translation service module 230 returns a first translation Q_{AB}. In response to the second translation request, the translation service module returns a second translation Q_{BA}. Both translations Q_{AB}, and Q_{BA} are machine-generated translations for the primary-language query suggestion Q. The suggestion service module 225 receives the two machine-generated translations Q_{BA} and Q_{AB} and determines which translation is a better choice for presentation as a cross-language query suggestion Q_{XY} for the primary-language query suggestion Q.

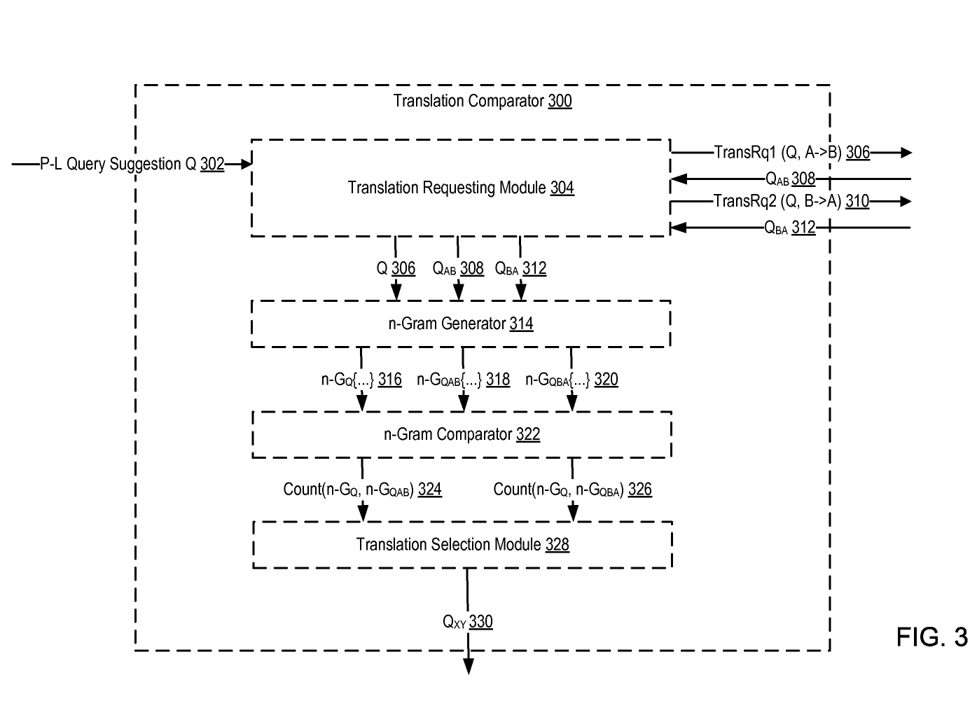

In some implementations, the translation comparator 235 of the suggestion service module 225 can implement the process for evaluating the pair of machine-generated translations Q_{AB} and Q_{BA}, and determining which one is a better choice as a cross-language query suggestion for the primary-language query suggestion Q. More details on the operations of the translator comparator 235 is provided later in this specification with respect to FIG. 3.

Once the suggestion service module 235 has identified the cross-language query suggestion Q_{XY} for the primary language query suggestion according to the techniques described in this specification, the suggestion service module 235 returns the identified machine-generated translation Q_{XY} (e.g., Q_{XY}=Q_{AB} or Q_{BA} depending on the result of the evaluation) to the module 210. The module 210 then presents the machine-generated translation Q_{XY} in parallel with the primary-language query suggestion Q as a cross-language query suggestion in a user interface 224 (e.g., the web page 100 shown in FIG. 1).

As set forth earlier, the first language and the second language used to specify the source and target languages of the translation requests can be the preferred languages for the primary-language query suggestions and the cross-language query suggestions, respectively. In some implementations, the preferred languages for the primary-language query suggestions and cross-language query suggestions can be user specified (e.g., as shown in the user interface element 120 FIG. 1). In some implementations, the preferred languages for the primary-language query suggestions and cross-language query suggestions can be provided by the search engine. For example, the preferred languages for the primary-language and cross-language query suggestions can be provided based on the most and second most commonly used languages of the past queries entered by the user 222.

In some implementations, in addition to the first and the second translation requests, the suggestion service module 225 can submit one or more other translation requests, where each translation request specifies a different pair of source and target languages. The machine-generated translations received in response to the additional translation request can be evaluated in the same way as the first and second translations described above, and considered as candidates for the cross-language query suggestion.

For example, one additional translation request can specify an auto-detected language for the primary-language query suggestion as the source language, and the user-specified preferred language for the cross-language query suggestions as the target language. Another additional translation request can specify the auto-detected language for the primary-language query suggestion as the source language, and the user-specified preferred language for the primary-language query suggestions as the target language. Other additional translation requests can reverse the source and target language specification for the above two additional translation requests. Each of the machine-generated translations can participate in the comparison with the primary language query Q as a candidate for the cross-language query suggestion for the primary-language query suggestion Q.

The suggestion service module 225 can repeat the above described process for each primary-language query suggestion generated from the user's query input q. In some implementations, the multiple translation requests are only sent and the comparison process carried out if the automatic language detection of the primary-language query suggestion is inconclusive according to predetermined rules (e.g., when words from multiple languages are found in the primary-language query suggestion, or when one or more words in the primary-language query suggestion are found in multiple different languages or writing systems).

In some implementations, the module 110 can present the primary-language query suggestions and cross-language query suggestions to the user 222 in a user interface 224 in real time, i.e., as the user 222 is typing characters in the search engine query input field. For example, the module 110 can present a first group of primary-language query suggestions and cross-language query suggestions associated with a first character typed by the user 222, and present a second group of primary-language query suggestions and cross-language query suggestions associated with a sequence of the first character and a second character in response to the user 222 typing the second character in the sequence, and so on.

FIG. 2A illustrates merely one example implementation of the translation request, comparison, and selection procedure for generating cross-language query suggestions. In FIG. 2A, the translation comparator 235 resides on the server side (e.g., in the suggestion service module 225). FIG. 2B illustrates another example implementation of translation request, comparison, and selection procedure for generating cross-language query suggestions. In FIG. 2B, a similar translation comparator 235′ resides on the client side or an intermediate server side (e.g., in the module 210).

As shown in FIG. 2B, in an example environment 200′, a module 210′ (e.g., a JavaScript script or plug-in software running on the client device 215′) monitors input 220 received in a search engine query input field from a user 222. The module 210′ receives the input 220 and automatically sends the input 220 to a suggestion service module 225′ as the input 220 is received. The suggestion service module 225′ determines a set of primary-language query suggestions Qs, and sends one or more of the primary-language query suggestions back to the client device 215′.

The translation comparator 235′ in the module 210′ then contacts a translation service module 230 and submits a number of translation requests for each primary-language query suggestion Q. In each of the translation request, the translation comparator 235′ specifies the source language and target language for the translation request according to the user-specified preferred language for primary-language query suggestions and the user-specified preferred language for cross-language query suggestions. As set forth earlier with respect to the translation comparator 235, the translation comparator 235′ in the module 210′ can also submit one or more additional translation requests with other source-target language pairs.

After receiving the machine-generated translations in response to the translation requests, the translation comparator 235′ determines which machine-generated translation is a better choice for presentation as a cross-language query suggestion for the primary-language query suggestion Q, in the same manner as described with respect to the translation comparator 235 in FIG. 2A. Based on the output of the translation comparator 235′, the module 210′ presents the identified machine-generated translation Q_{XY} (e.g., Q_{XY}=Q_{AB} or Q_{BA} depending on the result of the evaluation) to the user in a user interface 224.

FIGS. 2A and 2B illustrate example ways of dividing the tasks of requesting candidate translations, evaluating the candidate translations, and identifying the cross-language query suggestions based on the result of the evaluations. The tasks can be divided among the client side, an intermediate server, and/or the server side modules. A person skilled in the art can appreciate that other divisions of the tasks are possible.

FIG. 3 is a block diagram illustrating the operations of an example translation comparator 300. The example translation comparator 300 can serve as the translation comparator 235 in FIG. 2A and/or the translation comparator 235′ shown in FIG. 2B.

As shown in FIG. 3, the translation comparator 300 receives a primary-language query suggestion (Q) 302. The primary-language query suggestion (Q) 302 can be generated by the suggestion service module based on a user's original query input and provided to the translation comparator 300. The primary-language query suggestion Q includes a sequence of characters, where the sequence of characters forms one or more words in one or more languages or writing systems.

After the translation comparator 300 receives the primary-language query suggestion (Q) 302, the translation request module 304 generates a pair of translation requests 306 and 310, and submits the pair of translation requests to a machine translation service module (e.g., the translation service module 230 or 230′ shown in FIGS. 2A and 2B, respectively). The first translation request (TransRq_1(Q, A→B)) 306 requests a machine-generated translation for the primary-language query suggestion (Q) 302 from a language A to a language B, while the second translation request (TransRq_2(Q, B→A)) 310 requests a machine-generated translation for the primary-language query suggestion (Q) 302 from the language B to the language A. As set forth earlier with respect to FIGS. 2A and 2B, the language A can be a user-specified preferred language for the primary-language query suggestions, and the language B can be a user-specified preferred language for the cross-language query suggestions.

In response to the first translation request 306, a machine-generated translation (Q_{AB}) 308 is received by the translation request module 304. In response to the second translation request 310, a machine-generated translation (Q_{BA}) 312 is received by the translation request module 304. Each of the machine-generated translations 308 and 312 consists of a respective sequence of characters. The respective sequence of characters for each machine-generated translation can include characters from one or more languages or writing systems.

Once the translation request module 304 receives the machine-generated translations 308 and 312 for the primary-language query suggestion 302, the translation request module 304 forwards the machine-generated translations 308 and 312 to an n-Gram generator 314 of the translation comparator 300. The n-Gram Generator 314 generates a respective set of n-grams from each of the machine-generated translations 308 and 312 and the primary-language query suggestion 302. The value of n is a value common for each candidate translation as well as the primary-language query suggestion.

In one example, the value of n is chosen to be 2, such that a respective set of bi-grams are generated by the n-Gram generator 314 for each of the machine-generated translations 308 and 312 and the primary-language query 302. In some implementations, the set of n-grams generated from each sequence of characters (e.g., the sequence of characters for Q, Q_{AB}, or Q_{BA}) are segments of n characters generated in sequence from one end of the character sequence to the other end of the character sequence, and the last segment can have fewer than n characters. Using an earlier example where language A is Chinese, language B is English, Q=“Autobot [symbol] [symbol] ”, Q_{AB}=“Autobot toys”, and Q_{BA}=“ [symbol] ”. The set of n-grams generated from Q is n-G_{Q}={au, to, bo, t, [symbol] }, the set of n-grams generated from Q_{AB} is n-G_{QAB}={au, to, bo, t, to, ys}, and the set of n-grams generated from Q_{BA}=n-G_{QBA}={ [symbol] , [symbol] , [symbol] }. Other ways of generating the n-grams from each sequence of characters are possible.

After the sets of n-grams 316, 318, 320 for each of (1) the primary-language query suggestion 302, (2) the first translation 308 from language A to language B, and (3) the second translation 312 from language B to language A, respectively, are generated by the n-Gram Generator 314, the n-Gram generator 314 forwards the sets of n-grams 316, 318, 320 to the n-Gram comparator 322. The n-Gram comparator 322 compares the set of n-grams generated from the first translation 308, i.e., n-G_{QAB}{ . . . } 318, with the set of n-grams generated from the primary-language query suggestion 302, i.e., n-G_{Q}{ . . . } 316, and produces a count 324 (e.g., Count(n-G_{Q}, n-G_{QAB})) of common n-grams between the two sets of n-grams 318 and 316. The n-Gram comparator 322 also compares the set of n-grams generated from the second translation 312, i.e., n-G_{QBA} { . . . } 320 with the set of n-grams generated from the primary-language query suggestion 302, i.e., n-G_{Q} { . . . } 316, and produces a count 326 (e.g., Count(n-G_{Q}, n-G_{QBA})) of common n-grams between the two sets of n-grams 320 and 316.

Continuing with the example above, the number of common bi-grams between n-G_{QAB}={au, to, bo, t , to, ys} and n-G_{Q}={au, to, bo, t, [symbol] } is four, including {au, to, bo, t}. The number of common bi-grams between n-G_{QBA}={ [symbol] [symbol] , [symbol] } and {au, to, bo, t, [symbol] } is zero.

After the two counts 324 and 326 are produced by the n-Gram comparator 322, the counts 324 and 326 are provided to the translation selection module 328 of the translation comparator 300. The translation selection module 328 selects the translation Q_{XY} 330 that is associated with a smaller count of common n-grams as a more suitable cross-language query suggestion for the primary-language query suggestion 302. The translation selection module 328 can forward the selected translation Q_{XY} 330 (Q_{XY} can be either Q_{AB} or Q_{BA} depending on the count of n-grams each has in common with the primary-language query suggestion Q).

Continue with the example above, since the number of common bi-grams between n-G_{QBA}={ [symbol] , [symbol] , [symbol] } and {au, to, bo, t, [symbol] } is zero, which is smaller than the number of common bi-grams between n-G_{QAB}={au, to, bo, t, to, ys} and n-G_{Q}={au, to, bo, t, [symbol] }, the translation selection module 328 will select Q_{BA} “ [symbol] ” as the cross-language query suggestion Q_{XY} for the primary-language query suggestion “Autobot [symbol] ”.

As set forth earlier with respect to FIGS. 2A and 2B, in some implementations, one or more additional machine-generated translations can be obtained for the primary-language query suggestion Q based other source-target language specifications. For example, the translation request module 304 can sent another translation request for translating the primary-language query suggestion Q from an auto-detected language C to the language B (e.g., the preferred language for cross-language query suggestions), provided that language C is different from language B. In response to the additional translation request, an additional translation Q_{CB} can be received by the translation request module 304, and forwarded to the n-Gram generator 314. The n-Gram generator 314 can generate a set of n-grams (e.g., n-G_{QCB}{ . . . }) for the additional translation Q_{CB} in the same manner as for the other machine-generated translations (e.g., Q_{AB} and Q_{BA}). The n-Gram Comparator 322 can compare the set of n-grams n-G_{QCB}{ . . . } with the set of n-grams n-G_{Q}{ . . . }, and produce a count of the common n-grams between the two. The translation selection module 328 can consider the additional translation Q_{CB} as a candidate for the cross-language query suggestion for the primary-language query suggestion Q. The machine-generated translation that has the smallest number of n-grams in common with the primary-language query suggestion Q is chosen as the cross-language query suggestion Q_{XY} for the primary-language query suggestion Q.

In some implementations, if two machine-generated translations have the same number of n-grams in common with the primary-language query suggestion Q, the tie is broken by the query lengths of the two machine-generated translations. In some implementations, the machine-generated translation that has the smaller query length (e.g., as represented by the number of characters in the machine-generated translation) between two tied translations is chosen as the cross-language query suggestion Q_{XY}. The reason for choosing a shorter translation is that a shorter translation is likely to be a more concise query than a longer translation.

In the above examples, the n-Gram generator 314 generates the set of n-grams for the primary-language query suggestion and the machine-generated translations in the order that the n-grams appear in the respective sequences of characters of the primary-language query and each of the machine-generated translations. In some implementations, one or more white spaces or padding characters can be added to the respective sequence of characters for the primary-language query and/or the translations. The padding characters can be added at the beginning or the end of each respective sequence of characters, such that the set of n-grams generated from the respective sequence of characters do not include any segment that is shorter than n characters.

In some implementations, the n-Gram generator 314 and the n-Gram comparator 322 can be combined in function. For each machine-generated translation, a common n-gram is extracted and removed one by one from the respective sequences of characters of the translation and the primary-language query suggestion, until no more common n-grams exist in the remaining characters of the translation and the primary-language query suggestion. The total number of common n-grams extracted from each translation is tallied, and used to compare the translations against one another. Using this alternative processing method, the number of common bi-grams between G_{QAB}=“autobot toys” and G_{Q}=“autobot [symbol] ” is 4, including {au, to, bo, t}, while the number of common bi-grams between G_{QBA} “ [symbol] ” and “autobot [symbol] ” is 1, including { [symbol] }.

In some implementations, instead of counting the number of common n-grams between each machine-generated translation and the primary-language query suggestion, the number of different n-grams between each machine-generated translation and the primary-language query suggestion can be counted and used to determine which translation is a better choice as the cross-language query suggestion. For example, the translation that has the greatest number of different n-grams from the primary-language query suggestion can be considered a better choice as the cross-language query suggestion.

In the above example, n is chosen to be 2, and the number of common bi-grams is used as the measure to determine which machine-generated translation is a better choice as a cross-language query suggestion. In some implementations, other values of n can be chosen.

For example, in some implementations, the value of n can be chosen based on the average length of words and/or phrases in the languages involved in the translations, such as the user-specified preferred languages for the query suggestions, and the auto-detected language for the primary-language query suggestion, etc. For example, if the average lengths of words and/or phrases in the languages involved in the translations are relatively long, a greater value of n may be preferred to a smaller value of n.

For another example, in some implementations, the value of n can be chosen based on the respective lengths of the primary-language query suggestion and the candidate machine-generated translations. If the lengths of the primary-language query suggestion and the candidate machine-generated translations are all relatively long, a greater value of n may be preferred to a smaller value of n. If one or more of the primary-language query suggestion and candidate translations are relatively short, a smaller value of n may be preferred to a larger value of n.

For another example, in some implementations, the value of n can be chosen based on the degree of similarity between the languages involved in the translations. If the languages involved in the translations are similar languages (e.g., languages having the same root or similar alphabets), a greater value of n may be preferred to a smaller value of n. If the languages involved in the translations are very different in terms of character set and spellings, then a smaller value of n may be preferred to a greater value of n.

In some implementations, the value of n can be chosen based on a combination of two or more factors such as those described above.

It should be noted that the above description is only for illustration and a person skilled in the art can make various adaptations and modifications without departing from the scope and spirit of the described techniques.

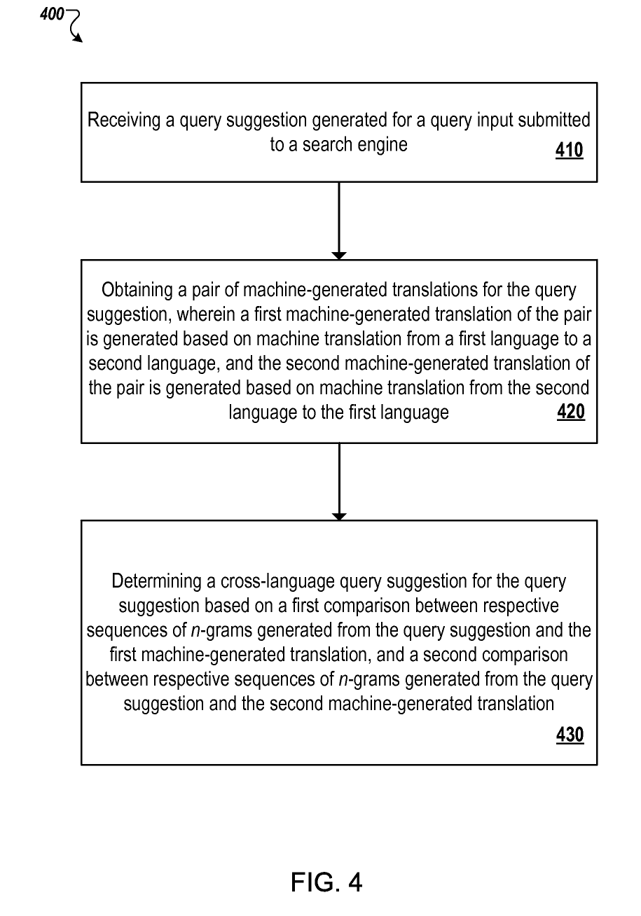

FIG. 4 is a flow diagram illustrating an example process 400 for evaluating candidate machine-generated translations of a primary-language query suggestion. Then, one of the candidate machine-generated translations is provided as a cross-language query suggestion for the primary-language query suggestion based on the evaluation. The example process 400 can be performed by the suggestion service module 225 in FIG. 2A, the module 210 in FIG. 2B, and/or the translation comparator 300, for example.

The example process 400 begins when a query suggestion generated for a query input submitted to a search engine is received (402). A pair of machine-generated translations are obtained for the query suggestion (404), where a first machine-generated translation of the pair is generated based on machine translation from a first language to a second language, and the second machine-generated translation of the pair is generated based on machine translation from the second language to the first language. Then, a cross-language query suggestion for the query suggestion is determined based on a first comparison and a second comparison (406). The first comparison is between respective sequences of n-grams generated from the query suggestion and the first machine-generated translation. The second comparison is between respective sequences of n-grams generated from the query suggestion and the second machine-generated translation, wherein n is an integer constant.

Other features of the above example process and other processes are described in other parts of the specification, e.g., with respect to FIGS. 1-3.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a computer-readable medium. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program, also known as a program, software, software application, script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

1. A computer-implemented method, comprising:
receiving a primary-language query suggestion generated for a query input submitted to a search engine;
obtaining a pair of machine-generated translations for the primary-language query suggestion, wherein a first machine-generated translation of the pair is generated based on machine translation from a first language to a second language, and the second machine-generated translation of the pair is generated based on machine translation from the second language to the first language, and wherein the first language is a user-specified preferred language for the primary-language query suggestion, and the second language is a user-specified preferred language for a cross-language query suggestion corresponding to the primary-language query suggestion;
determining a respective count of n-grams that each of the first machine-generated translation and the second machine-generated translation has in common with the primary-language query suggestion, wherein n is an integer constant; and
selecting one of the first machine-generated translation and the second machine-generated translation that has the smaller respective count of n-grams in common with the primary-language query suggestion as the cross-language query suggestion for the primary-language query suggestion.

2. A computer-implemented method, comprising:
receiving a query suggestion generated for a query input submitted to a search engine;
obtaining a pair of machine-generated translations for the query suggestion, wherein a first machine-generated translation of the pair is generated based on machine translation from a first language to a second language, and the second machine-generated translation of the pair is generated based on machine translation from the second language to the first language; and
determining a cross-language query suggestion for the query suggestion based on a first comparison between respective sequences of n-grams generated from the query suggestion and the first machine-generated translation, and a second comparison between respective sequences of n-grams generated from the query suggestion and the second machine-generated translation, wherein n is an integer constant.

3. The method of claim 2, wherein obtaining the pair of machine-generated translations for the query suggestion further comprises:
sending a first machine-translation request to obtain the first machine-generated translation of the query suggestion, the first machine-translation request specifying the query suggestion as a subject of the first machine-translation request, specifying a preferred language for primary-language query suggestions as a source language of the first machine-translation request, and specifying a preferred language for cross-language query suggestions as a target language of the first machine-translation request; and
sending a second machine-translation request to obtain the second machine-generated translation of the query suggestion, the second machine-translation request specifying the query suggestion as a subject of the second-machine translation request, specifying the preferred language for cross-language query suggestions as a source language of the second machine-translation request, and specifying the preferred language for primary-language query suggestions as a target language of the second machine-translation request.

4. The method of claim 2, wherein the first language and the second language are a pair of languages selected from a group of distinct languages including an automatically detected language for the query suggestion, a user-specified, preferred language for primary-language query suggestions, and a user-specified, preferred language for cross-language query suggestions.

5. The method of claim 2, further comprising:
generating the respective sequence of n-grams for each of the query suggestion, the first machine-generated translation, and the second machine-generated translation, from a respective sequence of characters forming the each of the query suggestion, the first machine-generated translation, and the second machine-generated translation, wherein each n-gram consists of n consecutive characters from the respective sequence of characters.

6. The method of claim 2, further comprising:
selecting a value for n based at least on respective lengths of the query suggestion, the first machine-generated translation, and the second machine-generated translation.

7. The method of claim 2, further comprising:
selecting a value for n based on at least the first language and the second language.

8. The method of claim 2, wherein n is 2.

9. The method of claim 2, wherein determining the cross-language query suggestion for the query suggestion further comprises:
identifying first common n-grams between the respective sequences of n-grams generated from the query suggestion and the first machine-generated translation;
identifying second common n-grams between the respective sequences of n-grams generated from the query suggestion and the second machine-generated translation; and
identifying one of the first and second machine-generated translations for which a smaller number of common n-grams have been identified, as the cross-language query suggestion for the query suggestion.

10. The method of claim 9, wherein determining the cross-language query suggestion for the query suggestion further comprises:
when an equal number of common n-grams have been identified for the first and second machine-generated translations, identifying one of the first and second machine-generated translations that has a smaller character length, as the cross-language query suggestion for the query suggestion.

11. A system, comprising:
one or more processors; and
memory having instructions stored thereon, the instructions, when executed by the one or more processors, cause the one or more processors to perform operations comprising:
receiving a query suggestion generated for a query input submitted to a search engine;
obtaining a pair of machine-generated translations for the query suggestion, wherein a first machine-generated translation of the pair is generated based on machine translation from a first language to a second language, and the second machine-generated translation of the pair is generated based on machine translation from the second language to the first language; and
determining a cross-language query suggestion for the query suggestion based on a first comparison between respective sequences of n-grams generated from the query suggestion and the first machine-generated translation, and a second comparison between respective sequences of n-grams generated from the query suggestion and the second machine-generated translation, wherein n is an integer constant.

12. The system of claim 11, wherein obtaining the pair of machine-generated translations for the query suggestion further comprises:
sending a first machine-translation request to obtain the first machine-generated translation of the query suggestion, the first machine-translation request specifying the query suggestion as a subject of the first machine-translation request, specifying a preferred language for primary-language query suggestions as a source language of the first machine-translation request, and specifying a preferred language for cross-language query suggestions as a target language of the first machine-translation request; and
sending a second machine-translation request to obtain the second machine-generated translation of the query suggestion, the second machine-translation request specifying the query suggestion as a subject of the second-machine translation request, specifying the preferred language for cross-language query suggestions as a source language of the second machine-translation request, and specifying the preferred language for primary-language query suggestions as a target language of the second machine-translation request.

13. The system of claim 11, wherein the first language and the second language are a pair of languages selected from a group of distinct languages including an automatically detected language for the query suggestion, a user-specified, preferred language for primary-language query suggestions, and a user-specified, preferred language for cross-language query suggestions.

14. The system of claim 13, wherein the operations further comprise:
generating the respective sequence of n-grams for each of the query suggestion, the first machine-generated translation, and the second machine-generated translation, from a respective sequence of characters forming the each of the query suggestion, the first machine-generated translation, and the second machine-generated translation, wherein each n-gram consists of n consecutive characters from the respective sequence of characters.

15. The system of claim 11, wherein the operations further comprise:
selecting a value for n based at least on respective lengths of the query suggestion, the first machine-generated translation, and the second machine-generated translation.

16. The system of claim 11, wherein the operations further comprise:
selecting a value for n based on at least the first language and the second language.

17. The system of claim 11, wherein n is 2.

18. The system of claim 11, wherein determining the cross-language query suggestion for the query suggestion further comprises:
identifying first common n-grams between the respective sequences of n-grams generated from the query suggestion and the first machine-generated translation;
identifying second common n-grams between the respective sequences of n-grams generated from the query suggestion and the second machine-generated translation; and
identifying one of the first and second machine-generated translations for which a smaller number of common n-grams have been identified, as the cross-language query suggestion for the query suggestion.

19. The system of claim 18, wherein determining the cross-language query suggestion for the query suggestion further comprises:
when an equal number of common n-grams have been identified for the first and second machine-generated translations, identifying one of the first and second machine-generated translations that has a smaller character length, as the cross-language query suggestion for the query suggestion.
